(19) United States
(12) Patent Application Publication
(10) Pub. No.: US 2015/0272157 A1
(43) Pub. Date: Oct. 1, 2015

(54) PACKAGED FOOD PRODUCT, ESPECIALLY CONFECTIONERY PRODUCT

(71) Applicant: MAGIC PRODUCTION GROUP (M.P.G.) S.A., Findel (LU)

(72) Inventors: Paolo VACCARELLA, Baldissero Torinese (Torino) (IT); Enrico PAVESI, Alba (Cuneo) (IT)

(73) Assignee: MAGIC PRODUCTION GROUP (M.P.G.) S.A., Findel (LU)

(21) Appl. No.: 14/668,402

(22) Filed: Mar. 25, 2015

(30) Foreign Application Priority Data
Mar. 25, 2014 (IT) TO2014A000246

(51) Int. Cl. A23G 1/54

(52) U.S. Cl. CPC A23G 1/545

(57) ABSTRACT

A packaged food product and process utilizes a first and a second half-shell of edible material. An openable container of non-edible material is interposed between the half-shells, having a wall that defines within it a volume for housing a product or accessory item. Between the edges of the half-shells, an empty gap is defined, that makes at least one annular portion of the wall of the container visible from the outside. Coverings of sheet material define a cavity substantially complementary to the outer surface of the respective half-shell of edible material, the coverings being connected together along their respective edges, so as to keep the half-shells of edible material in contact with the wall of the container.

### CROSS REFERENCE TO RELATED APPLICATIONS

This application claims priority from Italian Patent Application No. TO2014A000246 filed on Mar. 25, 2014, which is incorporated herein by reference in its entirety for all purposes.

### BACKGROUND OF THE INVENTION

The present invention relates to a pack for a food product, particularly for a confectionery product of the type comprising a first and a second hollow body or half-shell of edible material, the respective edges of the annular mouth of which are arranged in mutually facing relationship, so as to define a cavity in which an openable container of non-edible material is housed, which in its turn contains a product or an accessory item that constitutes a surprise for the consumer.

Such products have benefited from considerable commercial success and are marketed by Ferrero SpA with the trademark KINDER SORPRESA® [KINDER SURPRISE].

In the commercial product, the two half-shells of chocolate are generally welded together along the respective facing mouth edges and the food product is packaged in a covering of sheet material adhering to the outer surface of the product.

EP 2 252 528 B1 describes a solution in which, in order to facilitate opening of the packaging to gain access to the container of the surprise, the ovoid body of chocolate is packaged in two flanged half-shells of sheet material that are coupled together by folding and upsetting of the flange edges and in which the plane of separation of the half-shells of chocolate coincides with the plane of the flanges.

### BRIEF SUMMARY OF THE INVENTION

The present invention tackles the problem of supplying a packaged product in which, on opening the packaging, i.e. following removal of the packaging covering, there is simultaneous separation of the half-shells of edible material of the container of the surprise and which, moreover, allows the consumer, following removal of the covering, to have an immediate visual perception of the presence of the container.

A solution to this problem is described in EP 0 951 835 A and EP 1 018 302 A. In the packaging described in these documents, the container is provided with a rib, which the mouth edges of the edible half-shells come up against; this rib thus keeps the two edible half-shells separate and is visible from the outside following removal of the covering sheet. In this way, the consumer has an immediate perception of the presence of a non-edible body arranged between the edible half-shells.

However, a drawback of this solution is that both the inner surface, and the annular surface of the mouth edges of the half-shells of chocolate are completely in contact with the outer surface of the container, generally made of plastic, involving a risk of adhesion to said surfaces, for example following exposure to higher temperatures, with consequent deterioration of the product.

The present invention provides an alternative solution that overcomes the aforementioned drawback.

Thus, the invention relates to a packaged food product and a process for production thereof, having the features defined in the claims given hereunder, which constitute an integral part of the present description.

Further features and the advantages of the packaging according to the invention will become clear from the following detailed description, referring to the appended drawings, relating to the embodiment commonly adopted, but which is not imperative and does not limit the scope of the invention, in which the two half-shells of edible material are of semi-ovoid shape.

### BRIEF DESCRIPTION OF DRAWINGS

In the appended drawings:

FIG. 1 is a perspective view of the packaged product;

FIG. 2 is a partially sectional view of a first embodiment of the packaged product;

FIG. 3 is a partially sectional view of a second embodiment;

FIG. 4 is a partially sectional view of a third embodiment;

FIG. 5 is a partially sectional view of a fourth embodiment;

FIG. 6 is a front view of a product corresponding to that of FIG. 5, without the packaging covering; and

FIG. 7 is an exploded perspective view of the packaged product in the embodiment of FIG. 5.

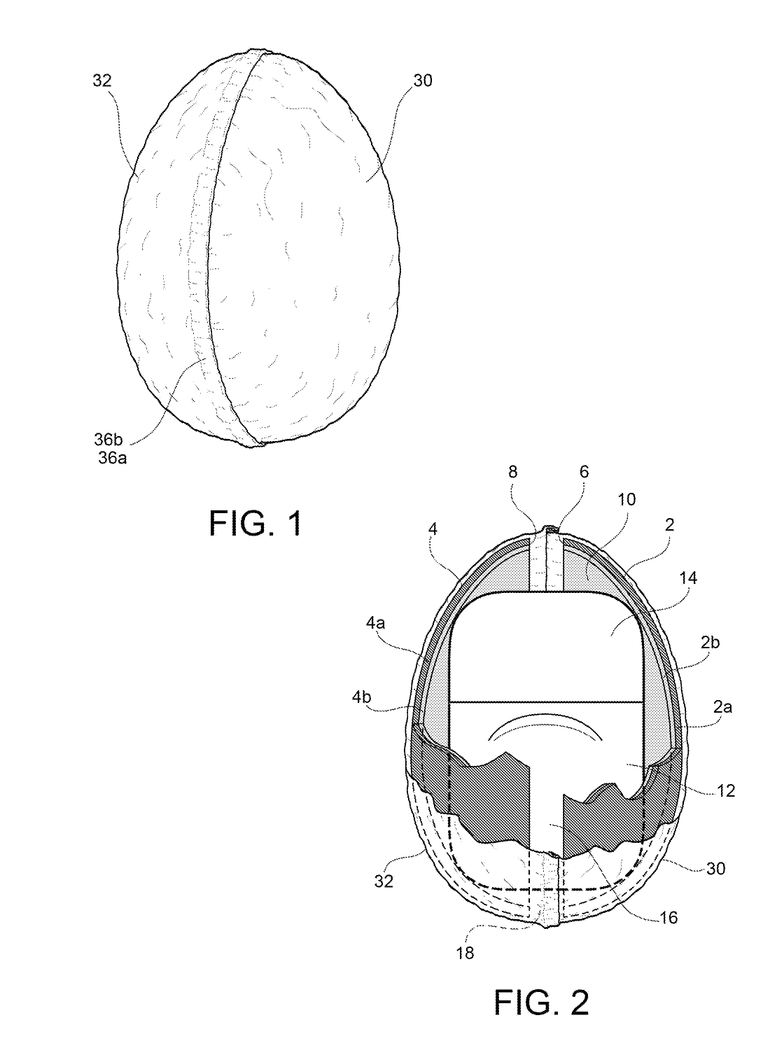

### DETAILED DESCRIPTION OF THE INVENTION

Referring to the drawings, the food product is formed from a first and a second half-shell 2 and 4 of semi-ovoid conformation. In all the illustrations, each half-shell is formed from two superposed layers 2a, 2b and 4a, 4b, for example of white chocolate and of milk chocolate, conforming to the product currently on sale.

The two half-shells 2 and 4 are arranged with the respective annular mouth edges 6 and 8 in mutually facing relationship, so as to define a cavity 10 in which a container 12 of non-edible material, typically made of plastic, is housed.

The two half-shells 2 and 4 are generally the same as each other; however, the edible part of the packaged product may also be produced using a pair of half-shells that are not the same as each other, for example having different depth, so that the respective annular mouth edges 6 and 8, which, in the solution according to the invention are spaced apart, need not necessarily fit together along their entire annular extension.

It is also intended that, whereas in the configurations illustrated the annular mouth edges 6 and 8 have an ovoid configuration, the invention is also applicable to the case when the edible part consists of two shells, one constituting the pointed end of the ovoid body and the other constituting the base part, in which the mutually facing annular mouth edges then have a circular annular configuration.

The container 12 is typically made of plastic suitable for contact with foodstuffs, such as for example polypropylene or copolymer of propylene and ethylene.

This container is in its turn formed from two half-shells 14 and 16, which can be coupled mouth to mouth by simple contact or with engaging means for front engagement so that, in the closed configuration of the container, they define within them a closed volume in which a product or an accessory item constituting the surprise is housed.

Preferably, the two half-shells are connected together permanently by articulating means, for example a film hinge or snap hinge.

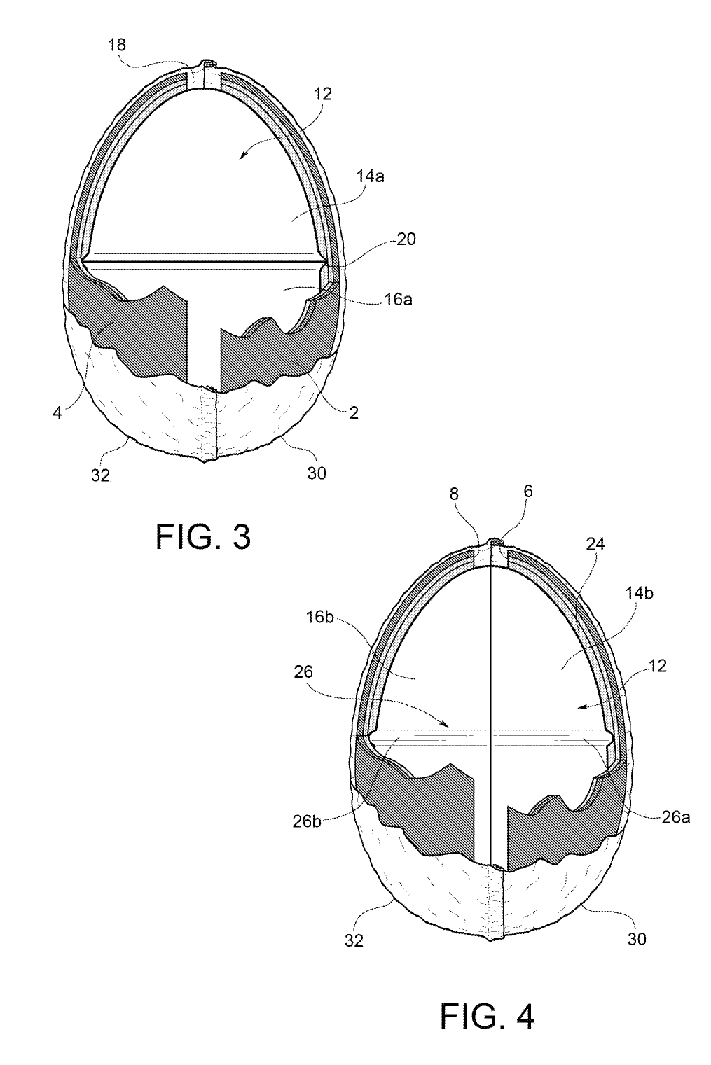

Preferably, the container 12, whatever its general conformation, has on its wall one or more rib formations (see for example ribs 20 and 26 in FIGS. 3 and 4), preferably extending in an orthogonal plane relative to the planes of the annular mouth edges 6 and 8, where said rib formation is in contact with the inner surface of both half-shells 2 and 4 of edible material.

As can be seen from the appended drawings, the container 12 adopted in the context of the invention may assume various forms and configurations; a feature common to all the embodiments is that the two edible half-shells and the container are shaped and dimensioned relative to one another in such a way that at least one wall portion of the container is arranged in contact with at least a portion of the inner surface of both half-shells so as to keep the facing edges 6 and 8 of the two half-shells 2 and 4 spaced apart.

Between the edges 6 and 8, an empty gap 18 is thus defined, which, in the absence of an outer packaging covering, makes at least one annular portion of the container wall immediately visible from the outside.

In the embodiment of FIG. 2, the container 12 has a substantially cylindrical configuration with convex or domed ends, made for example in conformity with the container for surprises described in WO 2005/110880 or WO 2007/074355.

The diameter of the container and its longitudinal extension are dimensioned relative to the dimensions of the half-shells 2 and 4 so that, in the assembled configuration of the packaging, each half-shell of the container, in its arched end region, is in contact with the inner surface of both edible half-shells 2 and 4.

In the embodiment of FIG. 3, the container 12 has an ovoid conformation formed from two half-shells 14a and 16a with a circular mouth edge, so that in the closed configuration of the container the mouth plane or plane of separation between the two half-shells extends orthogonally to the major longitudinal axis of the product; it is intended that the mouth profiles of the two half-shells 14a and 16a of the container may simply be in contact with one another, or the two half-shells may engage in one another for example by front engaging means.

The two half-shells 14a and 16a may moreover be connected to each other by a film hinge or snap hinge (not shown).

Preferably, at least one of the two half-shells 14a and 16a, or both half-shells, has/have, adjacent to the mouth edge, a rib formation, indicated overall with 20, which extends in a plane, preferably orthogonal to the plane of the mouth edges 6 and 8 of the edible half-shells. This rib is in contact with the inner surface of the edible half-shells 2 and 4, so that contact between the wall of the container 12 and the inner surface of the edible half-shells is limited to a restricted annular region, whereas most of the outer surface of the walls of the non-edible half-shells is not in contact with the inner surface of the edible shells 2 and 4.

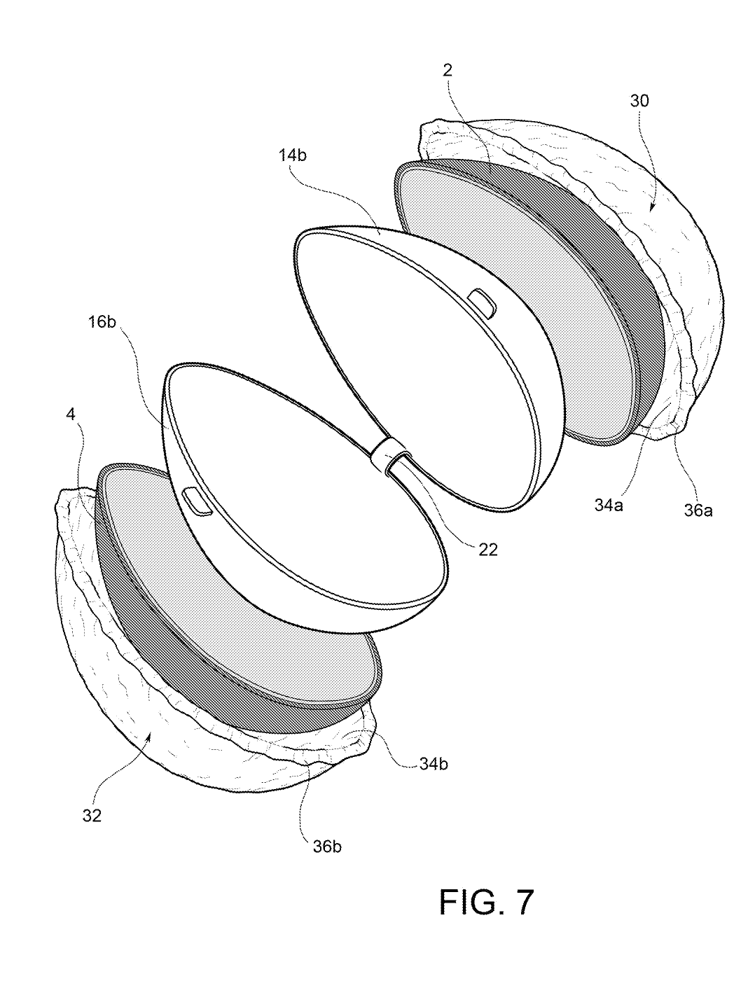

The embodiments in FIGS. 4, 5, 6 and 7 differ from that in FIG. 3 mainly in that the container 12, of ovoid shape, is formed from two half-shells 14b and 16b with an ovoid mouth profile. The two half-shells may be articulated together by a hinge or by a flexible tongue, as indicated with 22 in FIG. 7.

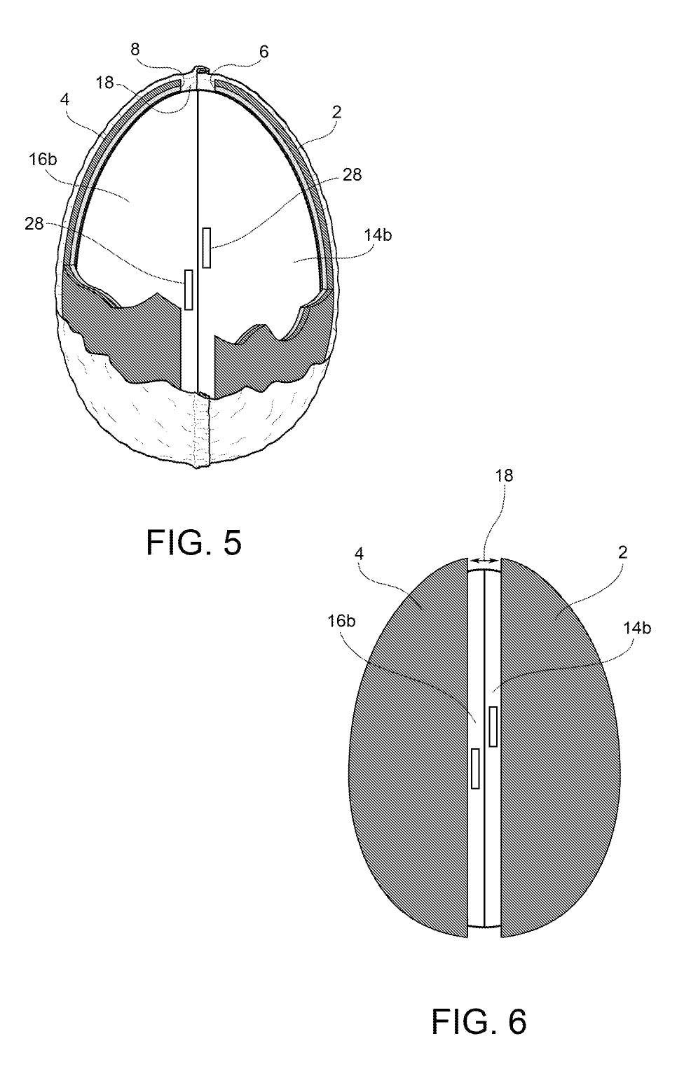

The inner surface of the edible half-shells 2 and 4 may be fully in contact with the outer surface of the non-edible half-shells 14b and 16b (FIG. 5); also in this embodiment the respective mouth edges 6 and 8 are separated. Alternatively, it is possible to envisage the presence, on the wall of the two half-shells 14b and 16b, of one or more ribs projecting radially outwards, dimensioned so as to be in contact with the inner surface of the edible half-shells, so as to maintain a gap 24 between the outer surface of the wall of the non-edible half-shells and the inner surface of the wall of the edible shells (FIG. 4).

An example of this embodiment is illustrated with the semi-annular ribs 26a and 26b in FIG. 4, which, in the closed configuration of the container 12, together form a circumferential annular rib 26.

It is intended that the wall of the container 12 can have one or more radially projecting ribs, the end of which is in contact with the inner surface of the wall of the edible half-shells.

Also in these embodiments, moreover, between the annular edges 6 and 8 of the edible half-shells, a gap 18 is defined, through which a portion of the container wall is visible.

To facilitate opening of the container, one or both of the half-shells of non-edible material 14b and 16b may have, adjacent to its mouth plane, a tongue 28 projecting outwards; the extension of tongue 28 is, however, such that its end does not protrude beyond the outer surface of the edible shells 2 and 4.

According to a further feature common to all the embodiments, the first and second edible half-shells are accommodated in a respective shaped covering of sheet material 30 and 32 that may be obtained using a metal sheet or foil, particularly aluminium, or may consist of a laminate of a metal foil with a polymer film, or else a metal sheet or foil coated with a heat-sealable lacquer.

Typically, they are sheets or films having a thickness from 6 μm to 40 μm, preferably from 8 μm to 20 μm, for example 12 μm.

Each covering 30 and 32 has a hollow receiving portion 34a, 34b shaped substantially complementary to the outer surface of the respective edible half-shell 2 and 4, so as to adhere to said surface and a peripheral portion 36a and 36b in the form of a flange.

The coverings 30 and 32 are initially associated with the respective edible half-shell 2 and 4 with portions of flange 36a, 36b in a superposed relationship; these portions are then coupled together by folding and/or upsetting, thus producing a releasable connection between the two coverings.

Alternatively, the peripheral portions in the form of a flange may be connected to each other by gluing or welding, which may be achieved by envisaging the presence of a heat-sealable lacquer on the facing peripheral surfaces.

Following welding, these peripheral portions that are welded together may be folded on themselves and optionally upset against the outer wall of one of the two coverings.

In this embodiment, it is preferable that the welded zone that makes it possible to obtain hermetic closure of the packaging is produced in an end region of the superposed peripheral portions in the form of a flange 36a and 36b or else in a region spaced from the receiving portion and that the folding of the flange, in the orthogonal or inclined direction relative to the plane of the superposed flanges, is effected along a folding line that does not pass through the welded zone, so that said welded zone is located in a distal region of the two folded flanges, in order to avoid damage to the chocolate by the heat emitted by the welding device.

According to the invention, the two coverings of sheet material, connected together along their flange edges by gluing, welding or folding/upsetting or with a combination of said methods, perform an appropriate function of retaining the edible half-shells in the assembled configuration of said packaging.

Although the use of these packaging coverings is known for example from EP 2 252 528 B1, this use has until now mostly been adopted for packaging a hollow body formed from two edible half-shells connected together; in this case, these coverings perform the conventional aesthetic function and protection function.

According to the invention, the two coverings described above, in addition to the aforementioned conventional aesthetic and protection functions, perform a retaining function, maintaining the two edible half-shells, which are separate from one another, in a relationship of contact with the non-edible container and with the annular facing edges in a substantially equidistant relationship.

To achieve the aforementioned retaining function, it is also possible to adopt two identical coverings of sheet material as illustrated above, or non-identical, i.e. a first covering wider than the other one, so that the plane in which the peripheral portions in the form of a flange 36a and 36b lie does not coincide with a plane of symmetry of the packaging and so is not equidistant from the separate mouth planes of the two half-shells of edible material.

To adopt this variant, the two coverings of sheet material may be shaped as described in EP 1110863 A. However, the invention is also applicable to identical covering half-shells.

The process for production of the packaging may be carried out by the following operations:
forming a first covering 32 of sheet material shaped with a receiving portion 34b and a peripheral portion in the form of a flange 36b;
inserting, in the first covering thus shaped, a first half-shell of edible material 4, the outer surface of which is shaped substantially complementary to the receiving portion of said first covering sheet and has a depth (understood as the distance between the mouth plane of said edible half-shell and the bottom of the half-shell) so that when the half-shell is inserted in the respective covering, its mouth plane is lowered relative to the plane of said peripheral portion of the covering;
inserting a container 12 of non-edible material into said edible half-shell;
positioning, in contact with the outer surface of the container 12, a second half-shell of edible material 2 with its mouth edges turned towards the mouth edges of the first half-shell of edible material, where the dimensions and the conformation of the container and of said half-shells of edible material are such that when the second half-shell of edible material is positioned resting on the outer wall of the container, the annular mouth edges of the first and second half-shells of edible material are separate from one another, between them defining an empty gap 18;
positioning, on the outer surface of the second shell of edible material, a second covering of sheet material 30, having a receiving portion 34a shaped substantially complementary to the outer surface of the edible half-shell 2 and a peripheral portion in the form of a flange 36a, where said second covering of sheet material 32 is dimensioned so that, when positioned in contact with the edible half-shell 2, its peripheral portion in the form of a flange 36a is in contact with the peripheral portion in the form of a flange 36b of the first covering sheet; and
coupling together said peripheral portions by the techniques mentioned above, comprising gluing, welding or folding of the flange edges and optional upsetting (in jargon: chamfering), or a combination of said techniques.

As mentioned above, joining the peripheral portions together makes it possible to maintain the integrity of the packaging; following removal of the covering, the two edible half-shells are separated and the presence of the container made of non-edible material immediately becomes perceptible.

Naturally, without prejudice to the principle of the invention, the embodiments and the details of implementation can be varied from that described as an example, while remaining within the scope of the claims given hereunder.

What is claimed is:

1. Packaged food product, comprising a first and a second half-shell of edible material, each having a respective annular edge, said first and second half-shell being arranged with their respective annular edges in mutually facing relationship, an openable container of non-edible material interposed between said half-shells, having a wall that defines within it a volume for housing a product or accessory item, the container being arranged with at least a portion of its wall in contact with at least a portion of the inner surface of said half-shells, wherein said first and second half-shell of edible material and said container are dimensioned and shaped in such a way that the container maintains in a spaced relationship the facing edges of said edible half-shells, so that between said edges an empty gap is defined, that makes visible from the outside at least one annular portion of the wall of the container, the first and the second half-shells of edible material are accommodated in a respective covering of sheet material defining a cavity substantially complementary to the outer surface of the respective half-shell of edible material, said coverings being connected together along their respective edges, so as to maintain the half-shells of edible material in contact with the wall of the container.

2. Packaged food product according to claim 1, wherein the wall of the container has at least one rib formation projecting towards the outside of the container in contact with the inner surface of both half-shells of edible material.

3. Packaged food product according to claim 2, wherein said at least one rib formation extends in a perpendicular or inclined plane with respect to the planes of the annular edges of the mouth of said half-shells of edible material.

4. Packaged food product according to claim 1, wherein the container comprises two half-shells whose outer surface is substantially complementary and in contact with the inner surface of the respective half-shell of edible material.

5. Packaged food product according to claim 1, wherein the container comprises two half-shells connected in articulation, whose annular mouth profiles lie in a plane substantially parallel to the planes of the annular edges of the mouth of the two half-shells of edible material.

6. A packaged food product according to claim 1, wherein said coverings of sheet material comprise a receiving portion and a peripheral portion in the form of a flange and in that said peripheral portions are connected to each other by gluing, welding, folding and/or upsetting or by a combination of gluing or welding with folding and/or upsetting.

7. Packaged food product according to claim 6, wherein the annular edges of the mouths of said half-shells of edible material are spaced apart and lie in a respective plane spaced from the plane in which said peripheral edges shaped as a flange of said coverings of sheet material lie.

8. Process for the production of a packaged food product, comprising a first and a second half-shell of edible material, each half-shell having an open mouth and respective annular edges of the mouth arranged in mutually facing relationship, an openable container of non-edible material interposed between said half-shells, having a wall that defines within it a volume for housing a product or accessory item, comprising the steps of:
dimensioning said first and second half-shell of edible material and said container in such a way that the container maintains the facing edges of said half-shells of edible material spaced apart, so that between said edges an empty gap is defined that makes visible from the outside at least one annular portion of the wall of the container and housing said first and second half-shell of edible material in a respective covering of sheet material, each covering having a receiving portion shaped substantially complementary to the outer surface of the respective half-shell of edible material and a peripheral portion in the form of a flange, and
connecting said peripheral portions so as to maintain the aforesaid half-shells of edible material in contact with the wall of the container.

9. Process according to claim 8, comprising the steps of:
forming a first covering of sheet material shaped with a receiving portion and a peripheral portion shaped as a flange;
inserting in said so shaped first covering a first half-shell of edible material, said half-shell being shaped in a form substantially complementary to the receiving portion of the respective covering and having a depth such that when the half-shell is inserted into the respective covering, its mouth plane is lowered with respect to the plane of said peripheral portion;
introducing said container in the half-shell of edible material;
positioning said second half-shell of edible material in contact with the outer surface of the container emerging from said first covering;
positioning said second covering of sheet material in contact with the outer surface of said half-shell of edible material, and
connecting their peripheral portions in the form of a flange of said first and second covering of non-sheet material.

10. Process according to claim 8, wherein said first and second coverings of sheet material are connected by gluing, welding, folding and/or upsetting or by a combination of gluing or welding with folding and/or upsetting of the respective peripheral portions shaped as a flange.
